(19) United States
(12) Patent Application Publication
(10) Pub. No.: US 2015/0070940 A1
(43) Pub. Date: Mar. 12, 2015

(54) MULTI-PHASE TRANSFORMER TYPE DC-DC CONVERTER

(71) Applicant: Renesas Electronics America Inc., Santa Clara, CA (US)

(72) Inventors: Tetsuo Sato, San Jose, CA (US); Kazuhito Ayukawa, Gunma (JP); Hiroshi Murakami, Hyogo (JP)

(21) Appl. No.: 14/299,186

(22) Filed: Jun. 9, 2014

Related U.S. Application Data
(60) Provisional application No. 61/875,143, filed on Sep. 9, 2013.

(51) Int. Cl. H02M 3/335

(52) U.S. Cl. CPC H02M 3/33507
USPC 363/17

(57) ABSTRACT

A multi-phase transformer type DC-DC converter. In one embodiment, the multi-phase transformer type DC-DC converter includes a plurality of DC-DC converters comprising a plurality of transformers, respectively, wherein the plurality of DC-DC converters are coupled in parallel between an input and an output. A circuit is coupled to the plurality of DC-DC converters and configured to generate a plurality of clock signals for use by the plurality of DC-DC converters, respectively, wherein the plurality of clock signals are phase shifted with respect to each other.

### RELATED APPLICATIONS

This application claims the domestic benefit under Title 35 of the United States Code §119(e) of U.S. Provisional Patent Application Ser. No. 61/875,143, filed on Sep. 9, 2013, entitled “Multi-Phase Transformer Type DC-DC Converter,” which is hereby incorporated by reference in its entirety and for all purposes as if completely and fully set forth herein.

### BACKGROUND OF THE INVENTION

Large data centers contain rows and rows of server racks, which consume substantial amounts of power at a high cost. Some data centers consume power more than 100 times that of a typical office building. For large power consuming data centers, electricity costs are a dominant operating expense and can account for over 10% of the total cost of ownership.

Local utilities provide power to data centers via power lines that have resistive elements R, which consume power P as a function current I (i.e., P=I²R). Utilities prefer to transmit power at high voltage and low current in order to minimize resistive power consumption. Data centers distribute power they receive to server racks and other components via internal power transmission lines that also contain resistive elements. Like utilities, data centers seek to minimize resistive power consumption in their power distribution lines by transmitting power to server racks at high voltage, low current. At some point, however, power must be converted to low voltage (e.g., 1.2 volts DC) and high current for use by components such as CPUs within the servers.

### SUMMARY OF THE INVENTION

A multi-phase transformer type DC-DC converter is disclosed. In one embodiment, the multi-phase transformer type DC-DC converter includes a plurality of DC-DC converters comprising a plurality of transformers, respectively, wherein the plurality of DC-DC converters are coupled in parallel between an input and an output. A circuit is coupled to the plurality of DC-DC converters and configured to generate a plurality of clock signals for use by the plurality of DC-DC converters, respectively, wherein the plurality of clock signals are phase shifted with respect to each other.

### BRIEF DESCRIPTION OF THE DRAWINGS

The present invention may be better understood in its numerous objects, features, and advantages made apparent to those skilled in the art by referencing the accompanying drawings.

FIG. 1 is a block diagram illustrating an example power distribution system that could be employed in a data center.

FIG. 2 is a block diagram illustrating an example DC-DC converter that could be employed in the example power distribution system of FIG. 1.

FIG. 3 is a timing diagram illustrating control signals employed in the DC-DC converter of FIG. 2.

FIG. 4 is a block diagram illustrating an example DC-DC converter that could be employed in the example power distribution system of FIG. 1.

FIG. 5 is a timing diagram illustrating example control signals employed in the DC-DC converter of FIG. 4.

FIG. 6 is a block diagram illustrating an example embodiment of the DC-DC converter shown in FIG. 4.

FIGS. 7A and 7B illustrate timing diagrams showing example control signals and voltages employed in the DC-DC converter of FIG. 6.

FIG. 8 is a block diagram illustrating an example embodiment of the DC-DC converter shown in FIG. 6.

FIG. 9 is a block diagram illustrating an example embodiment of the DC-DC converter shown in FIG. 6.

FIG. 10 is a block diagram illustrating an example embodiment of the DC-DC converter shown in FIG. 6.

FIG. 11 is a block diagram illustrating an example embodiment of the DC-DC converter shown in FIG. 6.

FIG. 12 is a block diagram illustrating an example embodiment of the DC-DC converter shown in FIG. 6.

The use of the same reference symbols in different drawings indicates similar or identical items.

### DETAILED DESCRIPTION

FIG. 1 illustrates a portion of an example system for distributing power to integrated circuits (e.g., CPUs) in server racks in a data center. For purposes of explanation only, the present invention will be described with reference to distribution of power to CPUs mounted on server printed circuit boards (PCBs) within server racks of a data center, it being understood the present invention should not be limited thereto.

With continuing reference to FIG. 1, AC-DC converter 102 is configured to convert high voltage, low current AC power into high voltage, low current DC power. An intermediate power transmission line transmits the high voltage, low current DC power from converter 102 to at least one rack of servers. The intermediate power transmission line contains resistive elements. Because power is transmitted at low current, these resistive elements consume relatively small amounts of power.

Server racks typically contain DC-DC converters, such as DC-DC converter 104, for converting power before it is transmitted to one or more server PCBs via a rack power transmission line 112. Like the intermediate transmission line, the rack power transmission line 112 contains resistive elements.

Server PCBs, relevant aspects of one of which are shown in FIG. 1, typically include a DC-DC converter 106 for converting power into a form (e.g., 1.2 volts DC, 150 amps) needed by a CPU 110. As an aside, CPUs can operate in different modes. For example, in a low data processing mode of operation, CPU 110 generally requires power at relatively low voltage (e.g., 1.2 volts DC). In a high data processing mode of operation, CPU requires power at higher voltage (e.g., 1.8 volts DC). DC-DC converter 106 should be able to provide a variable source of voltage Vout to the changing needs of CPU 110. Also, DC-DC converter 106 should be capable of quickly responding to changes in current and voltage demands of a CPU 110 during operation thereof.

As noted above, the rack power transmission line, like the intermediate power transmission line, includes resistive elements that consume power. If power is transmitted over the rack transmission line at high voltage and low current, the power costs associated with these resistive elements can be reduced. However, depending on the technology employed by DC-DC converter 106, there may be an upper limit on the input voltage Vin that DC-DC converter 106 can convert.

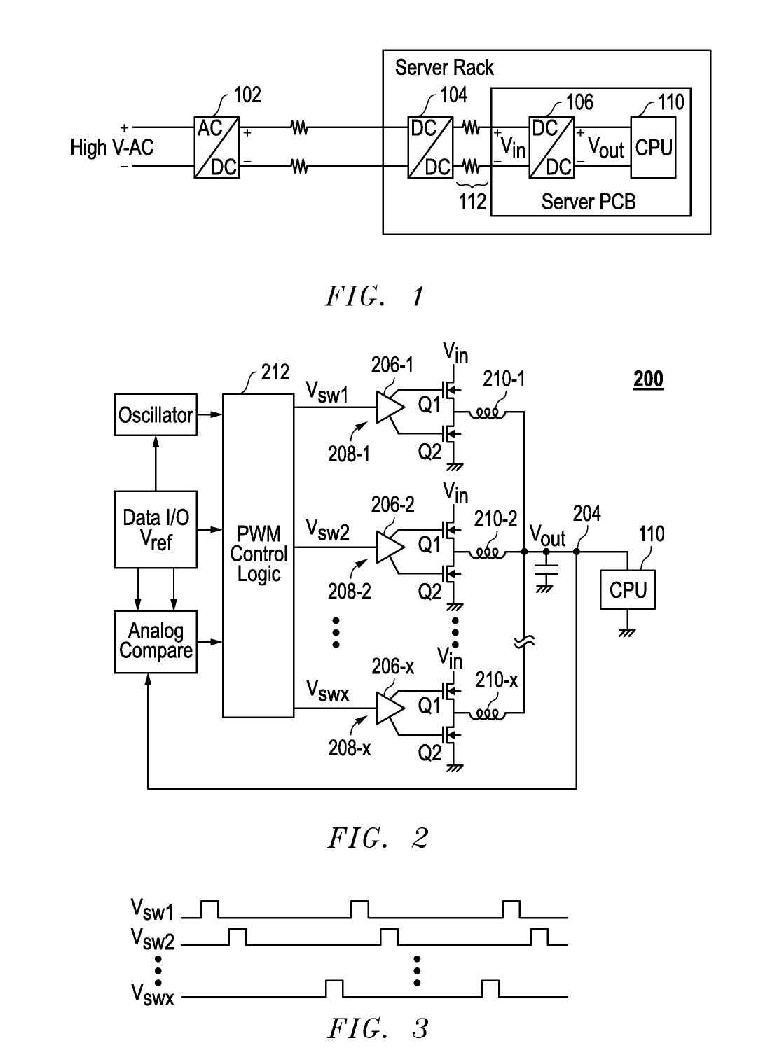

FIG. 2 illustrates one type of DC-DC converter 106. More particularly, FIG. 2 illustrates a non-isolated, multiphase step-down DC-DC converter 200. Each phase 208 includes high-side and low-side transistors Q1 and Q2 coupled to an inductor 210, which in turn is coupled to CPU 110 via an output node 204 as shown. For purposes of explanation, all transistors described herein will take form in n-channel or p-channel MOSFETs, it being understood the present invention should not be limited thereto.

Each phase 208 includes a driver circuit 206 that generates complementary, high-side and low-side square waves (not shown) that control transistors Q1 and Q2, respectively. Drivers 206 generate these square waves as a function of respective, phase shifted square wave inputs Vsw provided by PWM control logic 212. The duty cycle D of the square wave inputs Vsw is t1/(t1+t2). FIG. 3 illustrates examples of phase shifted square waves Vsw.

The pulses of high-side and low-side square waves activate Q1 and Q2, respectively. The high-side square wave provided to Q1 has a pulse width of t1, while the low-side square wave provided to Q2 has a pulse width of t2. Q1 transmits current to output node 204 via inductor 210 with each pulse of the high-side square wave, and Q2 transmits current from ground to output node 204 via inductor 210 with each pulse of the low-side square wave. Since the high-side and low-side square waves are complementary, which means they do not have overlapping pulses, only one of Q1 and Q2 in each phase transmits current at any given time. One of ordinary skill in the art understands that the magnitude of the output voltage Vout provided by DC-DC converter 200 depends on the duty cycle D=t1/(t1+t2) and Vin. More particularly, Vout=DVin for the non-isolated, multiphase step-down DC-DC converter 200.

Non-isolated, multiphase step-down DC-DC converter 200 is limited in its ability to convert a high voltage Vin to a low voltage Vout. For example, to convert Vin at 48 volts DC to Vout at 1.2 volts DC, the PWM control logic 212 must generate phase shifted square wave inputs Vsw having a very low duty cycle of D=0.025, which may be difficult if the frequency of Vsw is high. Additionally, the ability of converter 200 to quickly respond to changes in voltage and current demanded by CPU 110 may be difficult when Vsw has a small duty cycle.

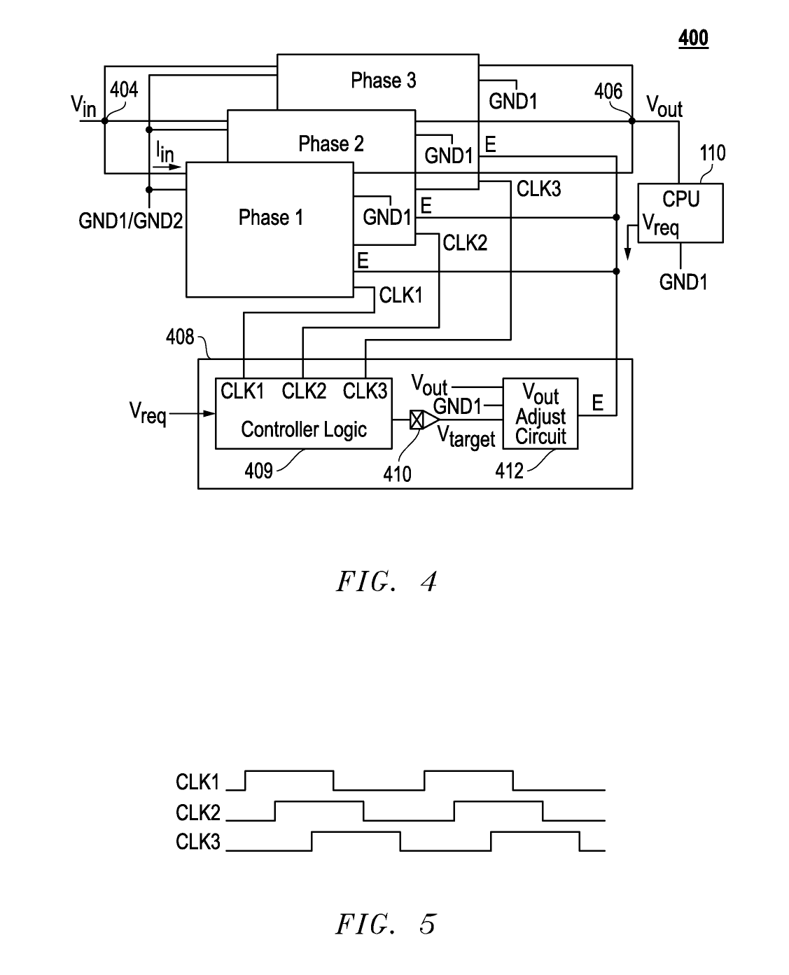

FIG. 4 illustrates relevant components of another type of DC-DC converter 106 that could be employed in FIG. 2. FIG. 4 illustrates an example multiphase, transformer-type DC-DC converter 400 according to one embodiment of the present invention. DC-DC converter 400 is capable of converting a relatively high input voltage Vin (e.g., Vin=48 volts DC) into a low output voltage Vout (e.g., Vout=1.2 volts DC) using control signals having larger duty cycles when compared to the duty cycle employed in DC-DC converter 200, while remaining very quick in responding to sudden changes in power demands of CPU 110.

DC-DC converter 400 includes three phases 1-3 coupled in parallel between input node 404 and output node 406. DC-DC converter 400 shown in FIG. 4 includes three phases, it being understood that alternative embodiments of the DC-DC converter 400 may include additional or fewer phases. Phases 1-3 should contain the same components in respective embodiments of DC-DC converter 400. As such phases 1-3 should operate identically in respective embodiments. For ease of illustration, the relevant components of phase 1 will be shown in each embodiment of DC-DC converter 400.

DC-DC converter 400 can be embodied as an isolated DC-DC converter 400 or a non-isolated DC-DC converter 400. In the isolated embodiment, CPU 110 is coupled to ground GND1, which is separate and electrically isolated from a second ground GND2 that is provided to each phase of DC-DC converter 400. In the non-isolated embodiment, a common ground (e.g., the first ground GND1) is employed by CPU 110 and throughout DC-DC converter 400.

DC-DC converter 400 includes a phase controller 408 coupled to and configured to control phases 1-3 in accordance with digital voltage request Vreq generated by CPU 110. Vreq can change as CPU 110 transitions between different modes of operation as will be more fully described.

Each of the phases 1-3 contains a transformer (not shown in FIG. 4) that includes primary and secondary windings. A transformer is a static electrical device that transfers energy by inductive coupling between its primary and secondary windings. Vp, the voltage across the primary winding is related to Vs, the voltage across the secondary winding. In general Vp/Vs is proportional to Np/Ns, where Np/Ns is the winding turns ratio between the primary and secondary windings. Vout, the output of DC-DC converter 400 is dependent on Vr, and thus Vp and the windings ratio. As will be more fully described below, DC-DC converter can change the output voltage Vout in response to a change in Vreq requested by CPU 110.

Phase controller 408 includes controller logic 409 that generates phase shifted clock signals CLK1-CLK 3 for controlling phases 1-3, respectively. FIG. 5 illustrates an example timing diagram of clock signals CLK1-CLK3 provided by controller logic 409. In the embodiment shown, clock signals CLK1-CLK3 are phase shifted by 60°. In the embodiment where DC-DC controller 400 contains more phases, phase controller will provide additional clock signals. For controllers with M phases, controller logic 409 will provide M clock signals CLK1-CLKM to respective phases, with the phase difference between them set to 180°/M in one embodiment. In the example shown in FIG. 5, the duty cycle D of each clock signal CLK1-CLK3 is 0.50. In one embodiment, controller logic 409 can change the frequency of clock signals CLK1-CLK3 in response to an externally received instruction from CPU 110 or other device.

DC-DC converter 400 is capable of converting a large Vin (e.g., Vin=48 volts DC) to a small Vout (e.g., Vout=1.2 volts DC) with internally generated pulse width modulation (PWM) signals (not shown in FIG. 4) having a relatively larger duty cycle. As will be more fully described below, the output voltage Vout is dependent on the windings ratio Np/Ns and the duty cycle of the internally generated PWM cycles. In one embodiment, a conversion of Vin=48 volts DC to Vout=1.2 volts DC can be accomplished with a windings ratio Np/Ns=0.167 and duty cycle of 0.15 for the internally generated PWM signals, which is substantially larger than the duty cycle of 0.025 that is needed by the DC-DC converter of FIG. 2 to implement the same conversion (i.e., Vin=48 volts DC to Vout=1.2 volts DC). The larger duty cycles reduce or eliminate many of the problems that plague the PWM control logic 212 and other components in FIG. 2.

Phase controller 408 receives Vreq from CPU 110 and Vout. Vreq is a digital signal that identifies a voltage level needed by CPU 110 for proper operation. Vreq can change over time depending on processing demands placed on CPU 110. Phase controller 408 contains a digital-to-analog converter (DAC) 410 that directly or indirectly receives Vreq, and generates Vtarget, an analog equivalent of Vreq.

Voltage adjust circuit 412 receives Vtarget and Vout, and generates a comparative voltage E as a function thereof. Comparative voltage E is provided to each phase of DC-DC converter 400, and is used to control the magnitude of Vout as will be more described below. In one embodiment, Vout varies directly with comparative voltage E; if Vout is lower than Vtarget, voltage adjust circuit 412 increases comparative voltage E until Vout equals Vtarget, and if Vout is greater than Vtarget, voltage adjust circuit 412 decreases comparative voltage E until Vout equals Vtarget.

Each of the phases 1-3 receives comparative voltage E from phase controller 408. Each phase 1-3 increases Vout as comparative voltage E increases, and each phase 1-3 decreases Vout as comparative voltage E decreases. Since phases 1-3 are identically configured, each phase generates the same voltage Vout.

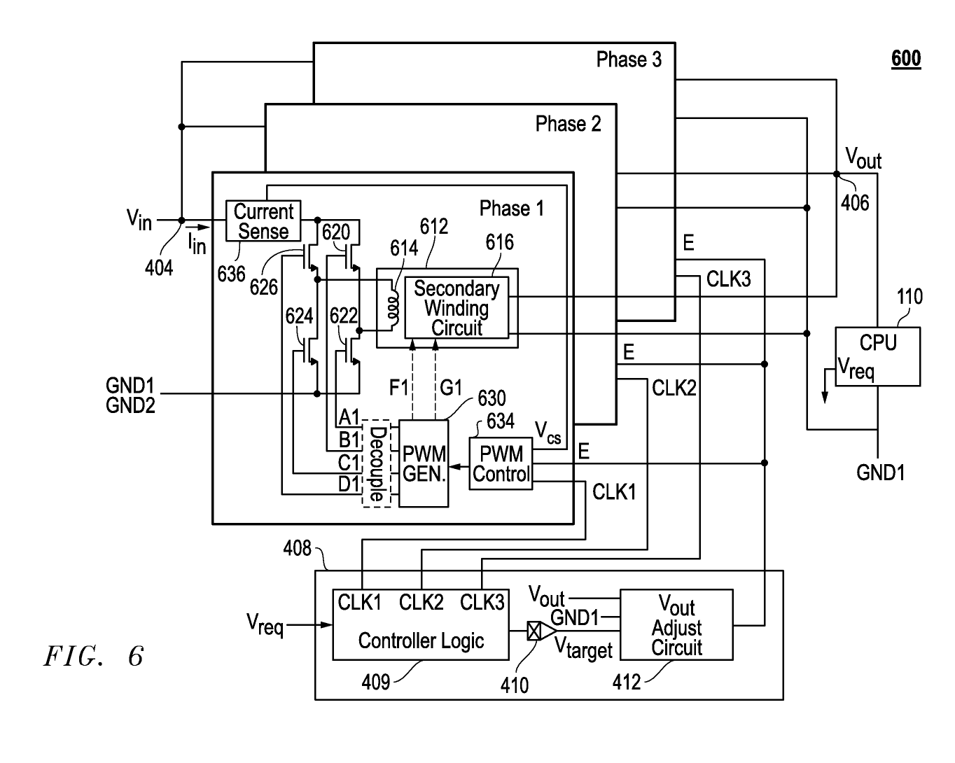

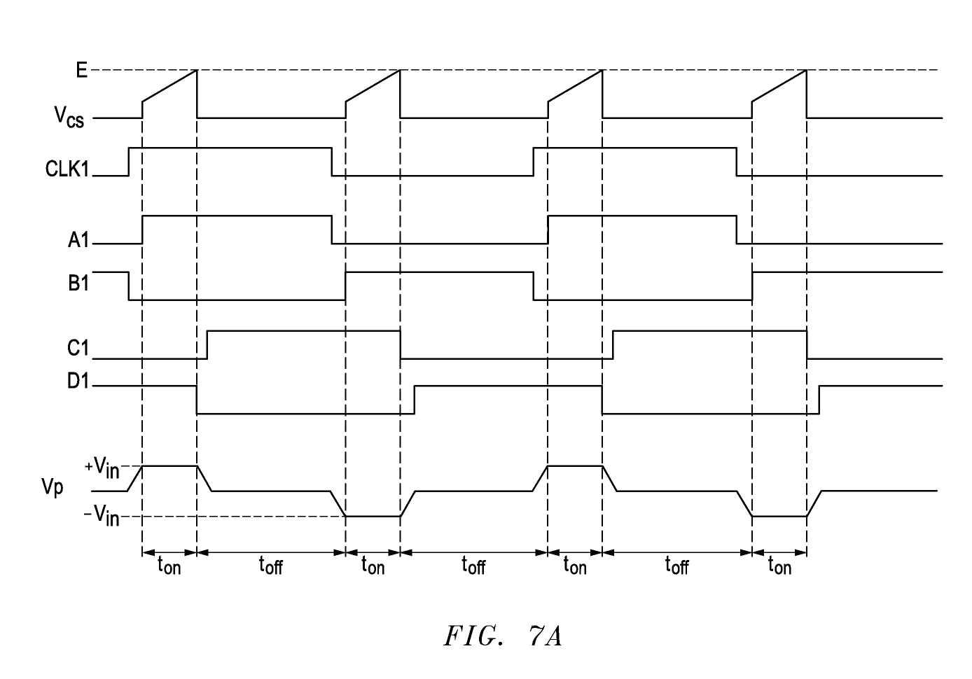

FIG. 6 illustrates relevant components of DC-DC converter 600, which is one embodiment of DC-DC converter 400. The relevant components of only phase 1 are shown, it being understood that phases 2 and 3 are identically configured. As seen in FIG. 6, phase 1 includes a transformer circuit 612, which includes a transformer. A primary winding 614 of the transformer is shown in FIG. 6. The secondary winding of the transformer is not shown in FIG. 6, but the secondary winding is contained within the secondary winding circuit 616, which generates Vout. The output of secondary winding circuit is coupled to output node 406. As will be more fully described, secondary winding circuit 616 rectifies the voltage across the secondary winding of the transformer.

A full-bridge circuit consisting of MOSFETs 620-626 controls the flow of current in primary winding 614 based on control signals A1-D1 generated by PWM generator 630. PWM generator 630 in combination with MOSFETS 620-626 generates a PWM voltage across the primary winding 614 as will be more fully described. In some embodiments of DC-DC converter 600, PWM generator 630 generates control signals F1 and G1 for controlling MOSFETs in secondary winding circuit 616 as will be more fully described below. The gates of MOSFETS 620-626 may be decoupled from PWM generator 630 via an optional decouple circuit 632 depending on whether DC-DC converter 600 is implemented as an isolated or non-isolated converter. Ground GND 1 is provided to MOSFETs 622 and 624 in the non-isolated version of DC-DC converter 600, and ground GND2 is provided to MOSFETs 622 and 624 in the isolated version of DC-DC converter 600. The decouple circuit 632 is configured to isolate ground GND2 provided to MOSFETs 620-626 and ground GND1 provided to secondary winding circuit 616 when DC-DC converter 600 is implemented in the isolated version.

Each phase includes a current sense circuit 636, which generates a voltage Vcs that is proportional to current flow En from input node 404 to the phase's primary winding 614. PWM controller 634 receives Vcs in addition to CLK1 and comparative voltage E. PWM controller 634 controls PWM generator 630, and thus control signals A1-D1, based on Vcs, CLK1, and comparative voltage E as will be more fully described below.

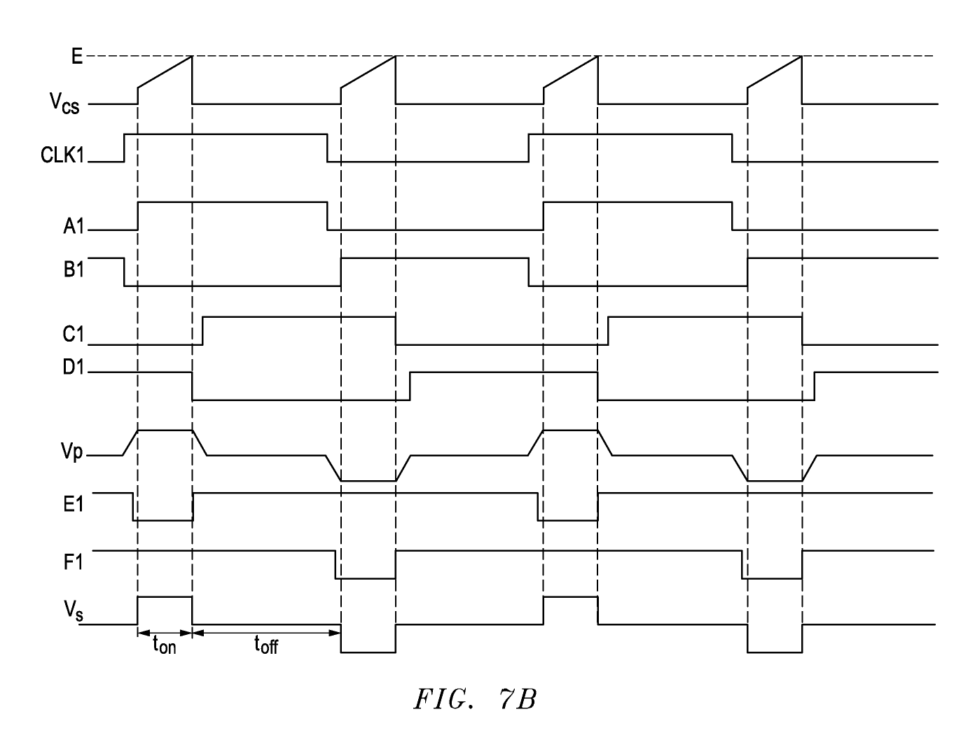

With continuing reference to FIG. 6, FIG. 7A is a timing diagram that illustrates example control signals A1-D1 generated by PWM generator 630. Control signals A1-D1 control MOSFETS 620-626, respectively, which in turn control current flow through primary winding 616. FIG. 7A also shows comparative voltage E and CLK 1 provided by phase controller 408, Vcs generated by current sense circuit 636, and Vp, which is the voltage across primary winding 614.

FIG. 7A shows tₒₙ, which is the time period during which MOSFETs 626 and 622 are activated by control signals D1 and A1, respectively, or when MOSFETs 620 and 624 are activated by control signals B1 and C1, respectively. During tₒₙ current from input node 404 flows through primary winding 614 and induces voltage Vp. During the first half cycle of CLK1 when MOSFETS 626 and 622 are activated, Vp is approximately equal to +Vin. During the second half cycle of CLK1 when MOSFETs 620 and 624 are activated, Vp is approximately equal to −Vin.

Current sense circuit 636 generates Vcs, which is proportional to current flow into primary winding 614 through MOSFET 636 or MOSFET 620. As current flow into primary winding 614 increases, Vcs increases in proportion. PWM control 634 receives and compares Vcs with comparative voltage E. When Vcs equals comparative voltage E during the first half cycle of CLK1, PWM control 634 generates a signal that instructs PWM generator 630 to de-assert control signal D1, which in turn deactivates MOSFET 626. When Vcs equals comparative voltage E during the second half cycle of CLK1, PWM control 634 generates a signal that instructs PWM generator 630 to de-assert control signal C1, which in turn deactivates MOSFET 626. One of ordinary skill understands that the length of tₒₙ can be adjusted by adjusting comparative voltage E; an increase in E results in a proportional increase in tₒₙ, and vice-versa.

Secondary winding circuit 616 will generate Vout proportional to Dₜ(Ns/Np)Vin, where Dₜ=tₒₙ/(tₒₙ+t_{off}), and where t_{off} is the time period between tₒₙ in respective cycles of CLK1. Since the length of tₒₙ can be adjusted by adjusting comparative voltage E, Vout can be adjusted by adjusting comparative voltage E. In other words, Vout will increase with tₒₙ, which increases when comparative voltage E increase. And Vout will decrease with tₒₙ, which decreases when comparative voltage E decreases. As noted above, comparative voltage E compare will increase or decrease until Vout equals Vtarget. Vreq is the digital equivalent of Vtarget. Accordingly, Vout will increase or decrease with a corresponding increase or decrease in Vreq.

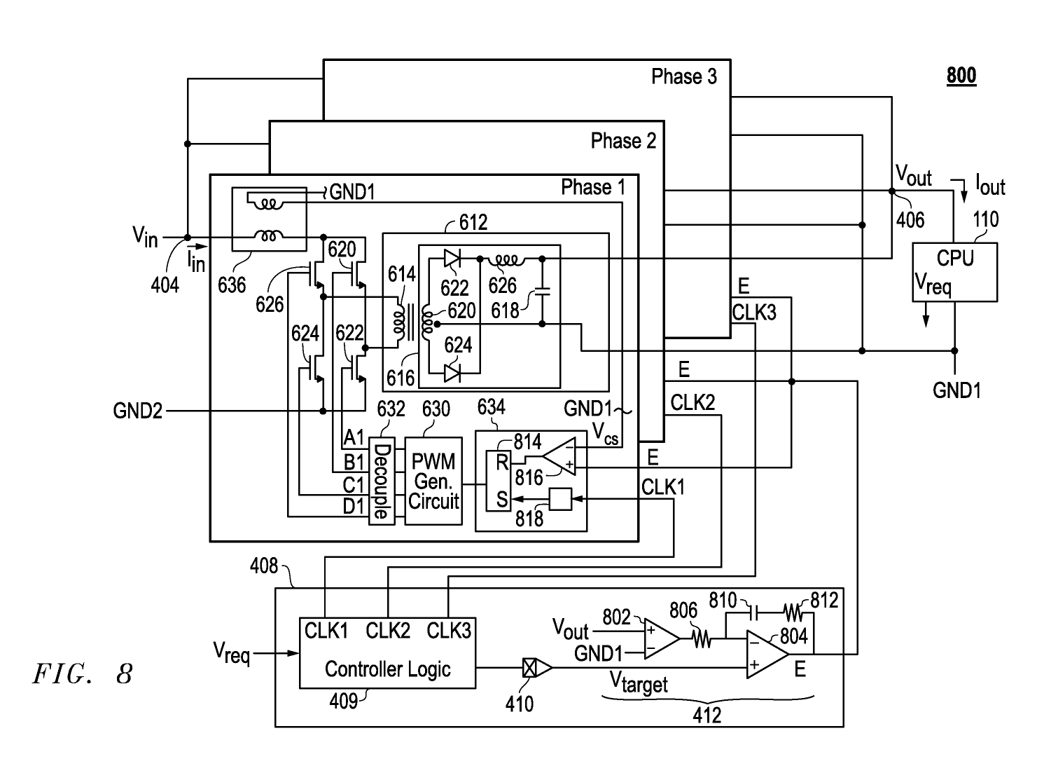

FIG. 8 illustrates one example of an isolated version of DC-DC converter 600 shown in FIG. 6. Voltage adjust circuit 412 in FIG. 8 includes amplifiers 802 and 804. Additionally, voltage adjust circuit 412 includes a pair of resistors and a capacitor arranged as shown. Sense amplifier 802 receives Vout and ground GND1 at its input terminals as shown. The output terminal of sense amplifier 802 is coupled to one input terminal of error amplifier 804 via resistor 806. This input terminal of error amplifier 804 is coupled to the output terminal of error amplifier 804 via capacitor 810 and resistor 812. The other input terminal of error amplifier 804 receives Vtarget, the analog equivalent of Vreq. Error amplifier 804 generates comparative voltage E at its output terminal. As noted above, comparative voltage E is provided to the PWM control circuit 634 in each phase 1-3. For purposes of explanation only, each version of DC-DC converter shown in the remaining figures will employ the same phase controller 408 that is shown in FIG. 8.

With continuation reference to FIG. 8, PWM control circuit 634 includes an SR flip flop 814, a voltage comparator 816, and a pulse generator 818. CLK1 is coupled to the input of pulse generator 818, which generates a set pulse with each rising or falling edge of CLK1. The output of comparator 816 is coupled to the R input terminal of flip flop 814, while the output of pulse generator 818 is coupled to the S input terminal of flip flop 814. The Q output of SR flip flop 814 is coupled to an input of PWM generator 630. For purposes of explanation only, each version of DC-DC converter shown in the remaining figures will employ the same PWM control circuit 634 that is shown in FIG. 8.

PWM generator 630 implements a state machine. With continuing reference to FIGS. 7A and 8, MOSFETs 622 and 624 are initially turned off or deactivated since control signals A1 and C1 are low, and MOSFETs 620 and 626 are initially turned on or activated since control signals B1 and D1 are high. In this state, no current flows from input node 404 to primary winding 614. The output of flip flop 814 is also initially set low. With the rising edge of CLK1, pulse generator 818 generates a set pulse, which switches the Q output of flip flop 814 to high. In response to this change in Q, PWM generator 630 deactivates MOSFET 620 via control signal B1, and after a small time delay PWM generator 630 activates MOSFET 622 via control signal A1 as shown. MOSFET 626 is active when PWM generator 630 activates MOSFET 622, and as a result Vcs ramps up as current increasingly flows to primary winding 614 via current sense circuit 636. Comparator 816 compares Vcs as it rises with comparative voltage E. When these two voltages are equal, the output of comparator 816 switches to low, which in turn switches the Q output of flip flop 814 to low. In response to this change in Q, PWM generator 630 deactivates MOSFET 626 via control signal D1, and after a small time delay PWM generator 630 activates MOSFET 624 via control signal C1 as shown. When MOSFET 626 deactivates, current no longer flows through current sense circuit 636, and Vcs falls, which in turn causes comparator 816 to quickly switch its output to low. The Q output of flip flop 814 should remain low when comparator 816 switches its output. With the falling edge of CLK1, pulse generator 818 generates another set pulse, which switches the Q output of flip flop 814 to high. In response to this change in Q, PWM generator 630 deactivates MOSFET 622 via control signal A1, and after a short time delay PWM generator 630 activates MOSFET 620 via control signal B1. MOSFET 624 is activated when PWM generator 630 activates MOSFET 620, and as a result Vcs begins to rise as current increasingly flows to primary winding 614 via current sense circuit 636. When Vcs equals comparative voltage E comparator 816 reasserts its output, which in turn switches the Q of flip flop 814 to low. In response PWM generator 630 deactivates MOSFET 624 via control signal C1, and after a short time delay PWM generator 630 activates MOSFET 626 via control signal D1. In this state, current does not flow through current sense circuit 636, and Vcs falls. The process repeats with the next rising edge of CLK1. For purposes of explanation only, each version of DC-DC converter shown in the remaining figures will employ the same PWM generator 630 that is shown in FIG. 8.

In the embodiment shown in FIG. 8, secondary winding circuit 616 includes a center-tapped, secondary winding 620 and diodes 622 and 624. One of ordinary skill understands the combination of diodes and transformer in FIG. 8 forms an example of a full wave rectifier. The secondary winding 620 is also coupled to inductor 626 via capacitor 628, the combination of which is coupled to output node 406 as shown. One of ordinary skill in the art understands that Vout is proportional Dₜ(Ns/Np)Vin when current flow through the primary winding 614 is controlled by the control signals A1-D1 shown in FIG. 7A. Further, current sense circuit 636 includes a transformer. Current flow between input node 404 and primary winding 614 induces Vcs. Since current sense circuit 636 includes a transformer in FIG. 8, current sense circuit 636 maintains electrical isolation of grounds GND1 and GND2.

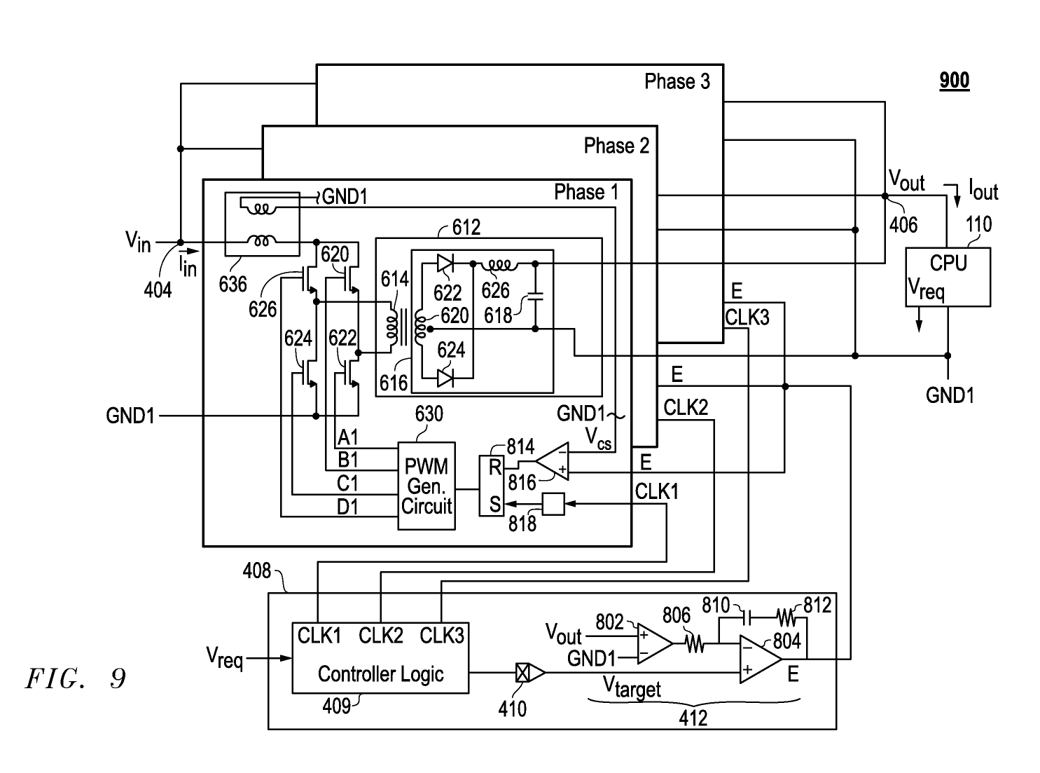

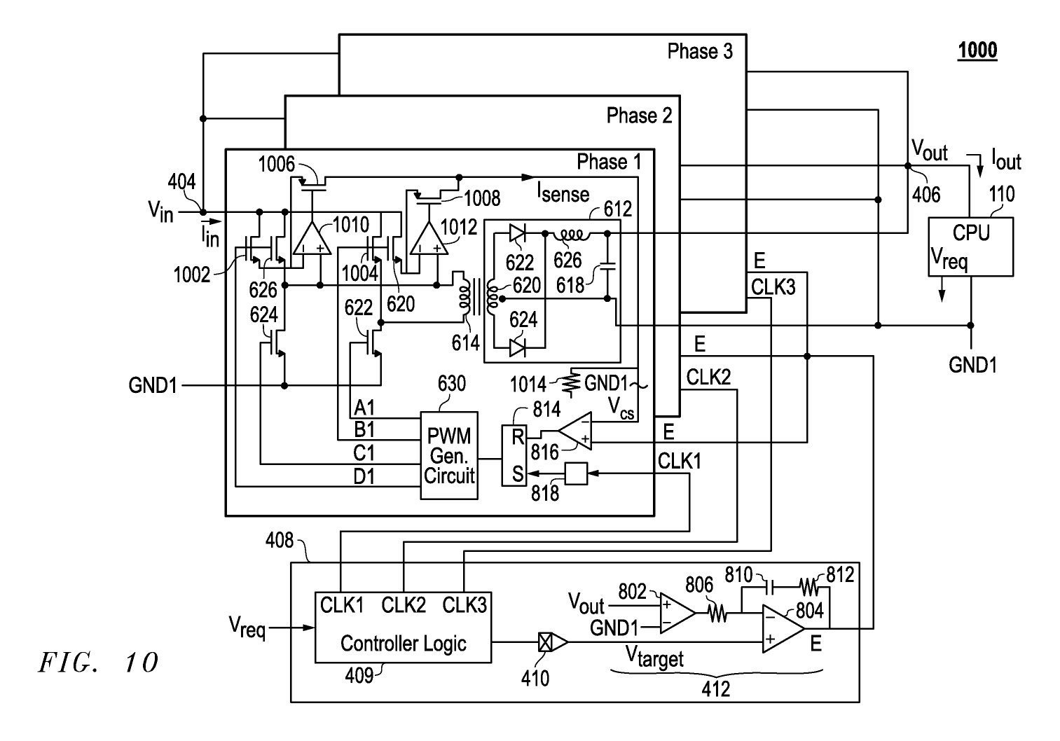

FIG. 9 illustrates a non-isolated embodiment of the DC-DC converter 800 shown within FIG. 8. More particularly, as seen in FIG. 9, DC-DC converter 900 lacks the decouple circuit 632 of DC-DC converter 800. Additionally, GND1 is coupled to MOSFETs 622 and 624 in DC-DC converter 900, as opposed to ground GND2 in DC-DC converter 800. The remaining components of DC-DC converter 900 shown in FIG. 9 operate in the same manner as their equivalents in a DC-DC converter 800 and described above.

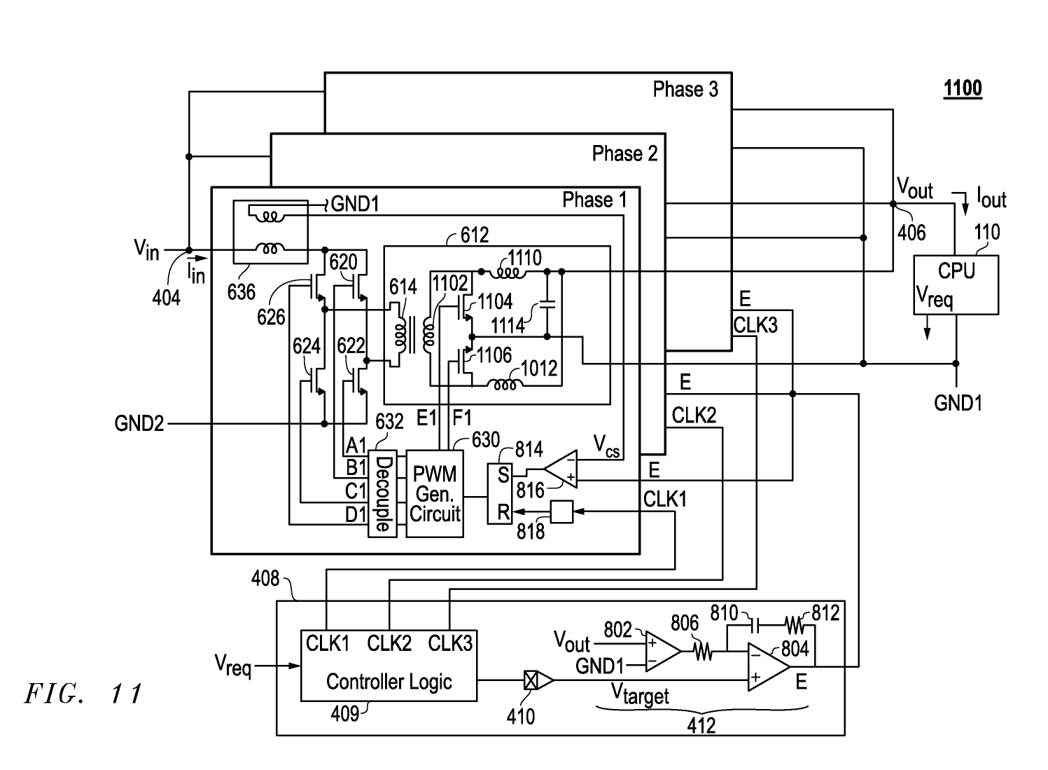

FIG. 10 illustrates another example of a non-isolated DC-DC converter. Like the non-isolated version shown in FIG. 9, DC-DC converter 1000 shown in FIG. 10 lacks decouple circuit 632, and MOSFETs 622 and 624 are coupled to ground GND1. Further, current sense circuit 636 takes form in a current sensing and measuring circuit that includes MOSFETs 1002-1008 coupled to operational amplifiers 1010 and 1012 as shown. MOSFETs 1002 and 1004 are controlled by control signals D1 and B1, respectively. In one embodiment, the current sensing and measuring circuit generates a current Isense as a function of phase 1 input current En provided via input node 404. Since virtually no current flows into terminals of comparator 816, Isense flow through resistor 1014 and generates voltage Vcs.

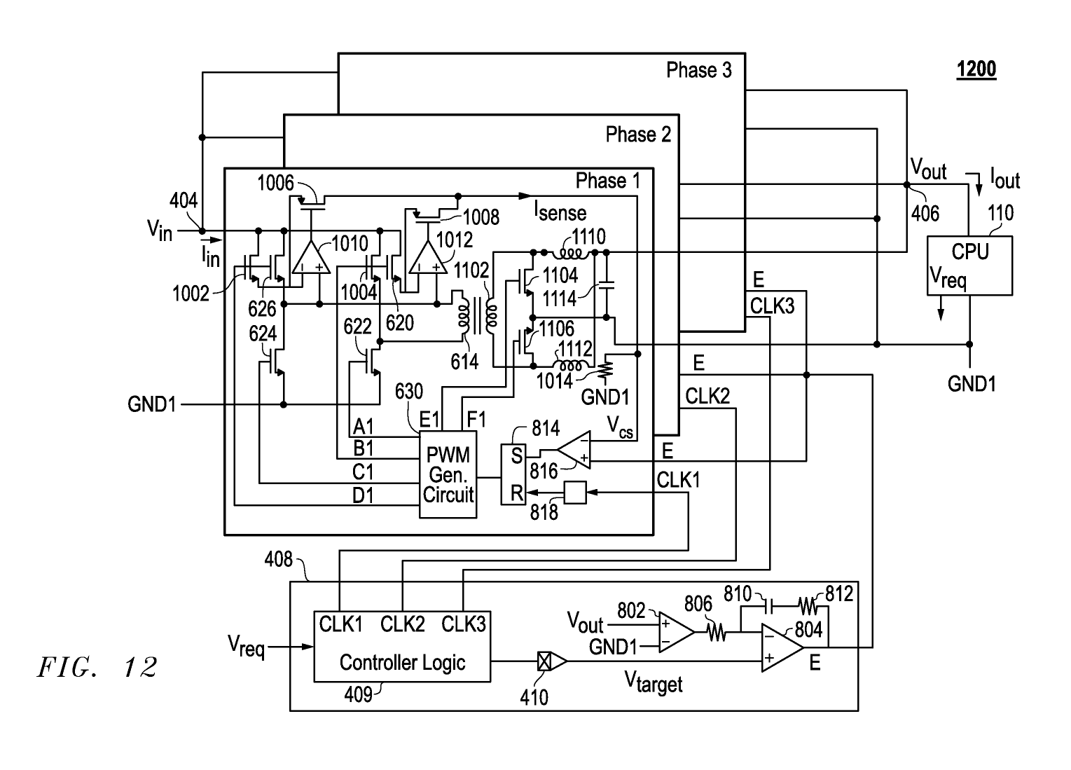

FIG. 11 illustrates an isolated version of DC-DC converter 600 shown within FIG. 6. In this version, the secondary winding circuit 616, however, is substantially different. Moreover, PWM generator 630 generates control signals E1 and F1 that control MOSFETs 1104 and 1106 as will be more fully described below. With continuing reference to FIG. 11, DC-DC converter 1100 includes a secondary winding 1102, the terminals of which are coupled to MOSFETs 1104 and 1106 as shown. Moreover, respective terminals of secondary winding 1102 are coupled to inductors 1110 and 1012 as shown. Capacitor 1114 is coupled between ground GND1 and output node 406. FIG. 7B illustrates the timing diagram shown in FIG. 7A in addition to the control signals E and F generated by PWM generator 430, and the voltage Vs across the secondary winding 1102. In the embodiment shown, control signals E1 and F1 control MOSFETs 1104 and 1106, respectively. Pulse generator 818 generates a set pulse with the rising edge of CLK1 in the same manner as described with reference to FIGS. 7A and 8. The set pulse is received by flip flop 814 and in response, flip flop 814 switches its Q output to high as described above. PWM generator 630, in response to receiving the change in the Q from flip flop 814, deactivates MOSFET 1104 via control signal E1 after a short time delay. During time t₀, Vcs increases until Vcs equates comparative voltage E. When these two voltages are equal, PWM generator 630 activates MOSFET 1104 via control signal E1 at the same time PWM generator 630 deactivates MOSFET 626 via control signal D1. In similar fashion, the PWM generator 630 deactivates MOSFET 1106 via control signal F1 shortly after the falling edge of CLK1 as shown in FIG. 7B. MOSFET 1106 remains deactivated during time t₀ until comparative voltage E and Vcs equate with each other, at which point PWM generator 630 activates MOSFET 1106 via control signal F1 and deactivates MOSFET 624 via control signal C1. This process continues with the next cycle of CLK1 as shown in FIG. 7B. This process results in the rectification of the secondary voltage Vs across capacitor 1114.

FIG. 12 illustrates a non-isolated version of the DC-DC converter shown within FIG. 6. DC-DC converter 1200 shown in FIG. 12 is substantially similar to the DC-DC converter 1100 shown within FIG. 11. However, DC-DC converter 1200 lacks the decouple circuit 632, and MOSFETs 624 and 622 are coupled to ground GND1 as shown. Additionally, the current sense circuit 636 takes form in the current sensing and measuring circuit described in the DC-DC converter 100 shown in FIG. 10. PWM generator 630 generates control signals E1 and F1 in the same manner as described with reference to FIG. 12.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. An isolated DC-DC converter comprising:
N full-bridge drivers, where N is greater than 1, for driving primary sides of N voltage and current transformers, respectively;
N full rectifiers coupled to secondary sides of the N voltage and current transformers, respectively, for driving an output to an output voltage;
wherein the N full-bridge drivers are controlled by respective sets of pulse width modulation (PWM) signals, wherein the sets of PWM signals are phase shifted with respect to each other, wherein the phase the sets of PWM signals depends on N, and wherein the sets of multiple PWM signals enable interleaving operation of the N full-bridge drivers;
wherein no direct current (DC) connection connects the primary and secondary sides of the voltage and current transformers.

2. The isolated DC-DC converter of claim 1 further comprising N circuits for generating first voltages, wherein the first voltages are proportional to current flow into the primary sides of respective voltage and current transformers.

3. The isolated DC-DC converter of claim 2 wherein widths of first PWM signals in respective sets of PWM signals, depend on the first voltages, respectively.

4. The isolated DC-DC converter of claim 3 further comprising:
N PWM generators for generating the N sets of PWM signals, respectively;
a circuit for generating an error voltage as a function of the output voltage and a target output voltage;
wherein the N PWM generators comprise N comparators, respectively, for comparing the error voltage with respective first voltages.

5. The isolated DC-DC converter of claim 3 wherein the N circuits comprise N current sense transformers, respectively, for generating the first voltages, respectively.

6. A non-isolated DC-DC converter comprising:
N full-bridge drivers, where N is greater than 1, for driving primary sides of N voltage and current transformers, respectively;
N full rectifiers coupled to secondary sides of the N voltage and current transformers, respectively, for driving an output to an output voltage;
wherein the N full-bridge drivers are controlled by respective sets of pulse width modulation (PWM) signals, wherein the sets of PWM signals are phase shifted with respect to each other, wherein the phase the sets of PWM signals depends on N, and wherein the sets of multiple PWM signals enable interleaving operation of the N full-bridge drivers;
wherein a direct current (DC) connection exists the primary and secondary sides of the voltage and current transformers.

7. The non-isolated DC-DC converter of claim 6 further comprising N circuits for generating first voltages, wherein the first voltages are proportional to current flow into the primary sides of respective voltage and current transformers.

8. The non-isolated DC-DC converter of claim 7 wherein widths of first PWM signals in respective sets of PWM signals, depend on the first voltages, respectively.

9. The non-isolated DC-DC converter of claim 8 further comprising:
N PWM generators for generating the N sets of PWM signals, respectively;
a circuit for generating an error voltage as a function of the output voltage and a target output voltage;
wherein the N PWM generators comprise N comparators, respectively, for comparing the error voltage with respective first voltages.

10. The non-isolated DC-DC converter of claim 7 wherein the N circuits comprise current mirror(s) for generating currents that are proportional to the currents flowing into the primary sides of respective voltage and current transformers.

11. An apparatus comprising:
a plurality of DC-DC converters comprising a plurality of transformers, respectively, wherein the plurality of DC-DC converters are coupled in parallel between an input and an output;
a circuit coupled to the plurality of DC-DC converters and configured to generate a plurality of clock signals for use by the plurality of DC-DC converters, respectively, wherein the plurality of clock signals are phase shifted with respect to each other.

12. The apparatus of claim 11 wherein the circuit is configured to generate a control signal for controlling the plurality of DC-DC converters, wherein the control signal is generated as a function of a voltage at the output.

13. The apparatus of claim 12 wherein the plurality of DC-DC converters comprise a plurality of PWM signal generators, respectively, for generating first PWM signals, respectively, for controlling the plurality of transformers, respectively.

14. The apparatus of claim 13 wherein the plurality of DC-DC converters comprise a plurality of first switches, respectively, for selectively coupling the input to a plurality of first terminals, respectively of the transformers, respectively, in accordance with the first PWM signals, respectively.

15. The apparatus of claim 14 wherein the plurality of first PWM signals are phase shifted with respect to each other.

16. The apparatus of claim 15 wherein the phase shift between the plurality of first PWM signals equals the phase shift between the plurality of clock signals.

17. The apparatus of claim 16 wherein a width of each of the first PWM signals depends on the control signal.

18. The apparatus of claim 17 wherein the DC-DC converters comprise a plurality of circuits, respectively, for generating first voltages, respectively, which are proportional to current flow to the plurality of transformers, respectively, wherein the width of the plurality of first PWM signals depends the first voltages, respectively.

19. The apparatus of claim 11 wherein each of the transformers comprises a primary winding and a secondary winding, wherein the primary winding is directly or indirectly coupled to a first ground terminal, but not a second ground terminal, and wherein the secondary winding is directly or indirectly coupled to the second ground terminal, but not the first ground terminal, wherein the first and second ground terminals are electrically isolated from each other.

20. The apparatus of claim 11 wherein each of the transformers comprises a primary winding and a secondary winding, wherein the primary winding is directly or indirectly coupled to a common ground terminal.
